(19) United States
(12) Patent Application Publication
(10) Pub. No.: US 2020/0154655 A1
(43) Pub. Date: May 21, 2020

(54) NON-INTRUSSIVE MONITORING TERMINAL FOR IRRIGATION SYSTEMS

(71) Applicant: LINDSAY CORPORATION, Omaha, NE (US)

(72) Inventors: Jeremy Dick, Olathe, KS (US); Matthew R. Andrews, Lenexa, KS (US)

(73) Assignee: LINDSAY CORPORATION, Omaha, NE (US)

(21) Appl. No.: 16/191,540

(22) Filed: Nov. 15, 2018

(51) Int. Cl. A01G 25/09; A01G 25/16; G08B 1/08; B05B 12/00

(52) U.S. Cl. CPC A01G 25/092; B05B 12/008; G08B 1/08; A01G 25/165

(57) ABSTRACT

A non-intrussive monitoring terminal that monitors operating states of an irrigation system and transmits related data to a remote irrigation monitoring system. The monitoring terminal may be installed on any irrigation system without connecting to the irrigation system's existing control system, electrical system, or water distribution system and includes a housing that may be attached to a water pipe or other component of the irrigation system; a sensor mounted in the housing that senses vibrations of the irrigation system and generates a corresponding sensor signal; and an electronic circuit electrically coupled with the sensor to evaluate attributes of the sensor signal to determine operating states of the irrigation system.

### BACKGROUND OF THE INVENTION

### 1. Field of the Invention

The present invention relates to agricultural irrigation systems. More particularly, the invention relates to a non-intrussive monitoring terminal for an irrigation system.

### 2. Background

Agricultural irrigation systems such as center pivot and lateral move irrigation systems are commonly used to irrigate crops. A center pivot irrigation system typically includes, among other things, a center pivot communicating with a pressurized water supply and a main section that moves about the center pivot to irrigate a circular or semi-circular field. The main section includes a number of mobile support towers connected to the center pivot and to one another by truss-type framework sections. The mobile support towers are supported on wheels that are driven by electric or hydraulic motors. A water distribution conduit is supported by the mobile support towers and framework sections, and a number of sprinkler heads, spray guns, drop nozzles, or other water emitters are spaced along the length of the conduit for irrigating crops below the irrigation system. Lateral irrigation systems are similar except they don't include center pivots and move in a relatively straight line rather than a circle.

It is desirable to monitor and control the amount of water delivered by an irrigation system to prevent over or under-watering of crops and to conserve water. Similarly, it is often desirable to deliver different amounts of water to different portions of a field to accommodate different soil conditions, types of crops, and the existence of roads, boundaries, etc. in the field. Thus, modern irrigation systems often include on-board control systems that receive and implement irrigation schedules to control the speed of their drive motors and/or the opening and closing of their water valves to deliver prescribed amounts of water to crops. But irrigation schedules often must be modified to account for the amount of water this is actually applied to crops, and irrigation systems sometimes don't operate as intended due to stuck valves, stuck relays, and/or power disruptions. Thus, modern irrigation systems also often include on-board sensors that track parameters such as water delivery, position, and speed and on-board communications or telemetry systems that transmit related data to remote computers or handheld devices so operators can remotely monitor the operation of their irrigation systems and alter irrigation schedules as-needed. For example, such sensors and telemetry systems may alert an operator when an irrigation system is stationary when it should be moving and/or when its discharging water when it shouldn't be. Similarly, such sensors and telemetry systems may provide information that necessitates changes in a prescribed irrigation schedule.

Unfortunately, older irrigation systems often don't have sophisticated control systems, sensors, and/or telemetry systems and therefore are more difficult to monitor and control remotely. Attempts have been made to retrofit older irrigation systems with more modern control systems, sensors, and/or telemetry systems, but this typically requires electrical connections and/or water taps into the irrigation systems' existing electrical systems and water pipes.

### SUMMARY

The present invention solves the above-described problems by providing a monitoring terminal that may be easily installed on an irrigation system that is already in service and that monitors certain operating states of the irrigation system and transmits related data to a remote irrigation monitoring system so that an operator may monitor operation of the irrigation system and the remote irrigation monitoring system may use data from the monitoring terminal to create and/or modify irrigation schedules. Importantly, the monitoring terminal may be installed on any irrigation system without connecting to the irrigation system's existing control system, electrical system, or water delivery conduits.

An embodiment of the monitoring terminal broadly includes a housing that may be attached to a water pipe or other component of an irrigation system; a sensor mounted in the housing that senses vibrations of the irrigation system and generates a corresponding sensor signal; an electronic circuit mounted in the housing and electrically coupled with the sensor to evaluate attributes of the sensor signal to determine operating states of the irrigation system; and a telemetry unit for transmitting signals representative of the detected operating states to a remote irrigation monitoring system.

The operating states of the irrigation system that are detected may relate to whether the irrigation system is stationary or moving and whether it is discharging water or not. Specific detected operating states may include, for example: a) the irrigation system is not moving and not discharging water; b) the irrigation system is not moving but discharging water; c) the irrigation system is moving and discharging water; or d) the irrigation system is moving but not discharging water.

In one embodiment, the electronic circuit evaluates both the magnitude and frequency spectrum of the sensor signal to determine the operating states of the irrigation system. For example, the electronic circuit may analyze the magnitude of the sensor signal to determine if the irrigation system is stationary or moving, and if the irrigation system is moving, may analyze frequencies of the sensor signal to determine whether the irrigation system is discharging water.

Some embodiments of the monitoring terminal may further comprise a power source mounted in or on the housing for powering the sensor, the electronic circuit, and the telemetry unit without any electrical connections to the irrigation system's electrical system. In one embodiment, the power source is a solar panel and a battery.

Some embodiments of the monitoring terminal may also include a GPS receiver for detecting positions of the irrigation system and providing position signals to be transmitted by the telemetry unit. Other embodiments of the monitoring terminal may also include a pressure transducer for directly sensing water pressures in the irrigation system and for generating corresponding signals to the transmitted by the telemetry unit.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures. For example, the principles of the present invention are not limited to center pivot irrigation systems, but may be implemented in other types of irrigation systems including linear move irrigation systems.

### BRIEF DESCRIPTION OF THE DRAWING FIGURES

Embodiments of the present invention are described in detail below with reference to the attached drawing figures, wherein:

FIG. 1 is a perspective view of an exemplary center pivot irrigation system on which a monitoring terminal constructed in accordance with embodiments of the present invention is shown mounted.

FIG. 1a is an exploded fragmentary perspective view of a portion of the irrigation system showing the mounting terminal in greater detail.

FIG. 2 is a block diagram depicting selected components of an embodiment of the monitoring terminal.

FIG. 3 is a block diagram depicting selected components of another embodiment of the monitoring terminal.

FIG. 4 is a flow diagram depicting exemplary steps in a method of the present invention or portions of a computer program of an embodiment of the present invention.

FIG. 5 is a flow diagram depicting exemplary steps in another method of the present invention or portions of a computer program of an another embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The present invention includes a monitoring terminal that may be easily installed on an irrigation system that is already in service and that monitors certain operating states of the irrigation system and transmits related data to a remote irrigation monitoring system so that an operator may monitor the irrigation system and the remote irrigation monitoring system may use data from the monitoring terminal to create and/or modify irrigation schedules. Importantly, the monitoring terminal may be installed on any irrigation system without connecting to the irrigation system's existing control system, electrical system, or water delivery conduits.

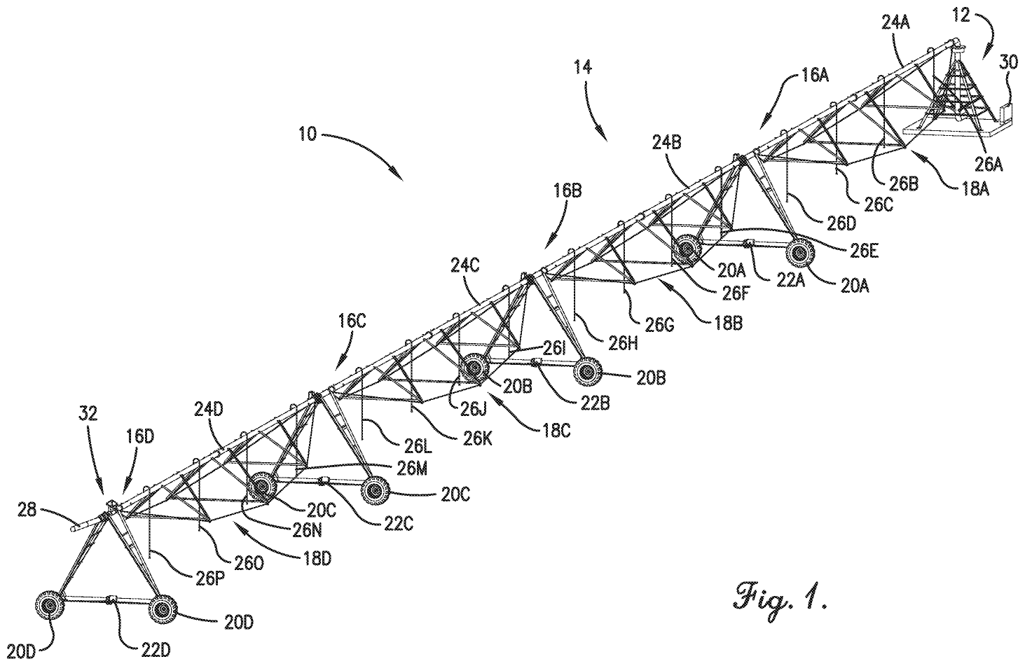

Turning now to the drawing figures, and initially FIG. 1, an exemplary irrigation system 10 on which the monitoring terminal of the present invention may be mounted is shown. The illustrated irrigation system 10 is a center pivot irrigation system, but it may also be a linear move or lateral type irrigation system or any other type of automated irrigation system. The illustrated irrigation system 10 broadly comprises a fixed center pivot 12 and a main section 14 pivotally connected to the center pivot.

The fixed center pivot 12 may be a tower or any other support structure about which the main section 14 pivots. The center pivot has access to a well, water tank, or other source of water and may also be coupled with a tank or other source of agricultural products to inject fertilizers, pesticides and/or other chemicals into the water for application during irrigation.

The main section 14 pivots or rotates about the center pivot 12 and includes a number of mobile support towers 16A-D, the outermost 16D of which is referred to herein as an end tower. The mobile towers are connected to the fixed center pivot 12 and to one another by truss sections 18A-D or other supports to form a number of interconnected spans. The illustrated irrigation system 10 has four mobile support towers, and thus four spans, however, it may comprise any number of towers and spans without departing from the scope of the invention

The mobile towers have wheels 20A-D driven by drive motors 22A-D. Each motor 22A-D turns at least one of the wheels 22A-D through a drive shaft to move its mobile tower and thus the main section 14 in a circle or semi-circle about the center pivot 12. The motors 22A-D may include integral or external relays so they may be turned on, off, and reversed by a control system described below. The motors may also have several speeds or be equipped with variable speed drives.

Although not required, some or all of the towers 16A-D may be equipped with steerable wheels pivoted about upright axes by suitable steering motors so that the towers can follow a predetermined track. As is also well known, the drive motors for the towers are controlled by a suitable safety system such that they may be slowed or completely shut down in the event of the detection of an adverse circumstance.

The mobile towers 16A-D and the truss sections 18A-D carry or otherwise support interconnected conduit sections 24A-D or other fluid distribution mechanisms that are connected to a source of fluids from the center pivot. A plurality of sprinkler heads, spray guns, drop nozzles, or other water emitters 26A-P are spaced along the conduit sections 24A-D to apply water and/or other fluids to land underneath the irrigation system.

One or more valves may be disposed between the conduit sections 24A-D and the water emitters 26A-P to control the flow of water through the water emitters. In some embodiments, the irrigation system includes several valves, and each valve controls the flow of water through a single water emitter such that each water emitter can be individually opened, closed, pulsed, etc. to emit any amount of water. In other embodiments, the irrigation system 10 includes several valves that each control the flow of water through a group of water emitters such that the group of water emitters is controlled to emit a specific amount of water. For example, each span of the irrigation system may include four water emitters, and one valve may control the water flow through all four water emitters such that all of the water emitters on a span operate in unison. The valves may be magnetic latching solenoid valves that are normally biased to an off/closed state such that the valves only switch to an on/open state when powered, but they may be any type of valve.

The irrigation system 10 may also include a flow meter that measures water flow rates through the system. Outputs from the flow meter may be provided to the control system. In one embodiment, a single flow meter measures flow rates through the entire irrigation system and provides an indication of this aggregate flow rate to the control system. In other embodiments, multiple flow meters provide flow-rate measurements through different portions of the irrigation system, such as through each span of the irrigation system or even each water emitter.

Embodiments of the irrigation system 10 may also include a pressure regulator for regulating the pressure of water through the irrigation system. Pumps that provide water to the irrigation system may be configured to provide a minimum water pressure, and the pressure regulator then reduces the pump water pressure to a selected maximum pressure level such that the pumps and pressure regulator together provide a relatively constant water pressure through the irrigation system.

The irrigation system 10 may also comprise other components such as an extension arm (also commonly referred to as a “swing arm” or “corner arm”) pivotally connected to the free end of the main section and/or one or more high pressure sprayers or end guns 28 mounted to the end tower 16D or to the end of the extension arm. The end guns are activated at the corners of a field or other designated areas to increase the amount of land that can be irrigated.

The irrigation system 10 may also comprise a control system 30 for controlling operation of the irrigation system. The control system can be located anywhere, such as in a panel beside the center pivot 12 as shown in FIG. 1, and can be implemented with hardware, software, firmware, or a combination thereof. One embodiment of the control system 30 may comprise a processing element, controller, or other computing device; conventional input devices such as knobs, buttons, switches, dials, etc.; inputs for receiving programs and data from external devices; one or more displays; a cellular or other radio transceiver for wirelessly receiving and transmitting data from and to remote devices; a bluetooth transceiver; a wifi transceiver; and/or other electronic components.

The control system 30 controls operational aspects of the irrigation system such as the speed and direction of the mobile towers, and hence the speed of the irrigation system, via control signals provided to the relays connected to the motors 22A-D of the mobile towers 11A-D. Likewise, the control system 30 controls the water flow through the water emitters 26A-P via control signals provided to the relays connected to the valves 28A-D. The control system 30 may also control other operational aspects such as a fertilizer application rate, a pesticide application rate, end gun operation, mobile tower direction (forward or reverse), and/or system start-up and/or shut-down procedures.

The control system 30 may control some of the above-described operational aspects of the irrigation system in accordance with an irrigation plan (also sometimes referred to as a “sprinkler chart” or “watering plan”). An irrigation plan specifies how much water to apply to a field, and sometimes to different portions of a field, based on various different criteria such as the types of crops to be irrigated; the soil conditions in various parts of the field; the existence of slopes, valleys, etc. in the field; the existence of roads, buildings, ponds, and boundaries that require no irrigations; crop growth cycles; etc. One or more irrigation plans may be created then stored in memory associated with the control system.

The monitoring terminal of the present invention will now be described in more detail. The monitoring terminal may be installed anywhere on the irrigation system 10 and monitors operating states of the irrigation system and transmits related data to a remote irrigation monitoring system so that an operator may monitor the irrigation system and the remote irrigation monitoring and control system may use data from the monitoring terminal to create and/or modify irrigation schedules. Importantly, the mounting terminal performs these functions without connecting to the irrigation system's electrical systems or tapping into its fluid distribution conduits.

A monitoring terminal 32 constructed in accordance with embodiments of the present invention is shown in FIGS. 1a, 2, and 3. The monitoring terminal 32 includes a housing 34; a sensor 36; a location-determining component 38; an electronic circuit 40; a telemetry unit 42; and a power source 44. Other embodiments of the mounting terminal 32 may include other components as described below.

The housing 34 encloses or supports the above-listed components to protect them from moisture, vibration, and impact. The housing 34 may be positioned and attached anywhere on the irrigation system, but is preferably attached to the last mobile tower 16D as shown in FIG. 1. In one embodiment, the housing 34 is configured to be attached to the conduit section 24D of the tower 16D with straps, brackets, or other fasteners. The housing 34 may be constructed from any suitable vibration- and impact-resistant materials such as, for example, plastic, nylon, aluminum, or any combination thereof and may include one or more appropriate gaskets or seals to make it substantially waterproof or water resistant. Although the electronic components of the monitoring terminal are preferably mounted together within the housing 34, they need not be, since wireless communication among the various depicted components is possible and intended to fall within the scope of the present invention. Thus, components of the monitoring terminal may be located remotely from the housing 34 and from each other.

The sensor 36 senses vibrations of the irrigation system and generates a corresponding sensor signal. An embodiment of the sensor is an accelerometer, but it may be a strain gauge, electromagnetic velocity sensor, acoustic sensor, or any other electronic device or component operable to sense vibrations and generate a corresponding sensor signal. In some embodiments, the monitoring terminal 32 may include more than one sensor.

The location-determining component 38 detects positions of the irrigation system and generates corresponding position signals. The location-determining component may be a global navigation satellite system (GNSS) receiver such as a GPS receiver, Glonass receiver, Galileo receiver, or compass system receiver operable to receive navigational signals from satellites to calculate positions of the mobile towers as a function of the signals. The GNSS receiver may include one or more processors, controllers, or other computing devices and memory for storing information accessed and/or generated by the processors or other computing devices and may include or be coupled with a patch antenna, helical antenna, or any other type of antenna. The location-determining component may calculate positions of the irrigation system and generate corresponding position signals to be transmitted by the telemetry unit 42 or may simply relay satellite signals to the telemetry unit so that the remote irrigation monitoring and control system may calculate the positions of the irrigation system.

The location-determining component 38 may also comprise other type of receiving devices capable of receiving location information from at least three transmitting locations and performing basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

The location-determining component 38 may also be an angle encoder for sensing angles between the center pivot 12 and the main section 14 and/or one or more modified cam switches, proximity switches, optical encoders, potentiometers, light bar sensors, etc. at one of the joints of the irrigation system.

The electronic circuit 40 is coupled with the sensor 36 and evaluates attributes of the sensor signal to determine operating states of the irrigation system. The electronic circuit also generates corresponding monitoring signals and sends them to the remote irrigation monitoring and control system via the telemetry unit 42.

The electronic circuit 40 may comprise or include any number or combination of processors, controllers, ASICs, computers or other control circuitry and includes data inputs for receiving data from the sensor and the location-determining component and outputs connected to the telemetry system. The electronic circuit 40 may also comprise internal or external memory for storing the sensor signals, the location signals, the monitoring signals, and/or other signals and data. The memory may be any electronic memory that can be accessed by processing elements of the electronic circuit and operable for storing instructions or data. The memory may be integral with the electronic circuit or may be a stand-alone device. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the processing elements of the electronic circuit or may communicate over a bus or other mechanism that facilitates direct or indirect communication.

The electronic circuit 40 is programmed to determine operating states of the irrigation system 10 based on the sensor signals from the sensor 36. In some embodiments, the electronic circuit may also analyze output signals from other components of the monitoring terminal when determining the operating states. The operating states of the irrigation system that are detected may include whether the irrigation system is stationary or moving and whether it is discharging water or not. Specific states may include, for example: a) the irrigation system is not moving and not discharging water, b) the irrigation system is not moving but discharging water, c) the irrigation system is moving and discharging water, or d) the irrigation system is moving but not discharging water. In one embodiment, the electronic circuit 40 evaluates both the magnitude and frequency spectrum of the sensor signals to determine the operating states of the irrigation system. The electronic circuit analyzes the magnitude of the sensor signal to determine if the irrigation system is stationary or moving, and if the irrigation system is moving, analyzes frequencies of the sensor signal to determine whether the irrigation system is discharging water. More specific operating state detection schemes are disclosed below.

The telemetry unit 42 is coupled with the electronic circuit 40 and location-determining component 38 and is operable for transmitting data and signals to the remote irrigation monitoring system. The transmitted data and signals may include, for example, the monitoring signals output from the electronic circuit, including signals and other data representative of the current operating state of the irrigation system 10 (moving, not moving, discharging water, not discharging water, etc) and the current location of the irrigation system. Such signals and data may be used to remotely monitor the operation of the irrigation system and/or to make changes in an irrigation schedule.

The telemetry unit 42 may include one or more transceiver elements. The transceiver elements may include signal or data transmitting and receiving circuits, such as antennas, amplifiers, filters, mixers, oscillators, digital signal processors (DSPs), and the like. The transceiver elements may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver elements may utilize communication standards such as ANT, ANT+, Bluetooth™ low energy (BLE), the industrial, scientific, and medical (ISM) band at 2.4 gigahertz (GHz), or the like.

The power source 44 is mounted in or on the housing 34 for powering the sensor 36, the location-determining component 38, the electronic circuit 40, and the telemetry unit 42 without any electrical connections to the electrical system of the irrigation system. In one embodiment, the power source 44 includes a solar panel and a battery that can be charged and re-charged by the solar panel. In other embodiments, the power source may be a coil that converts magnetic fields generated by the irrigation system into electricity to charge a battery.

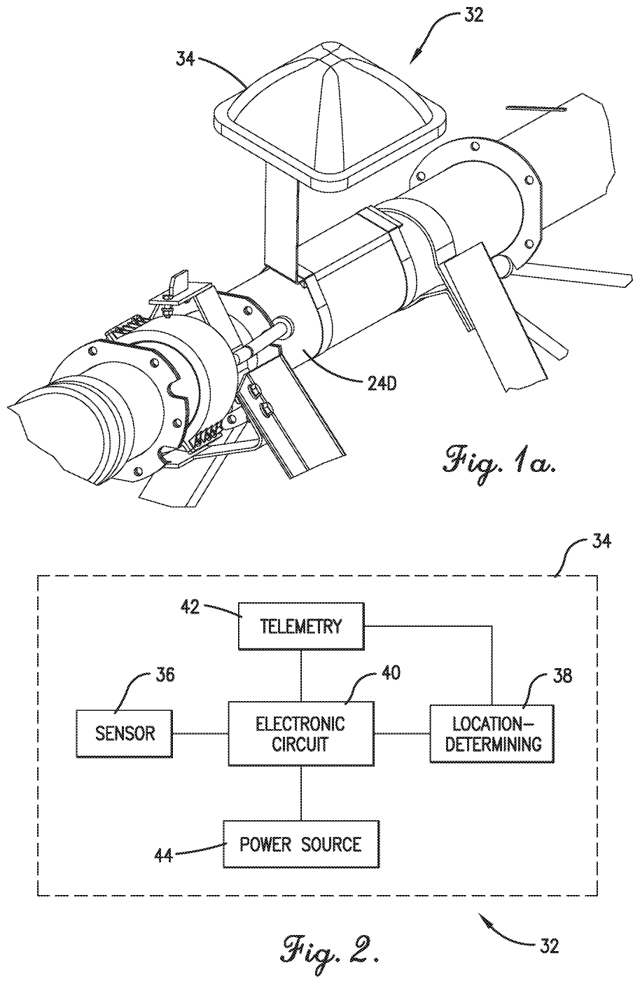

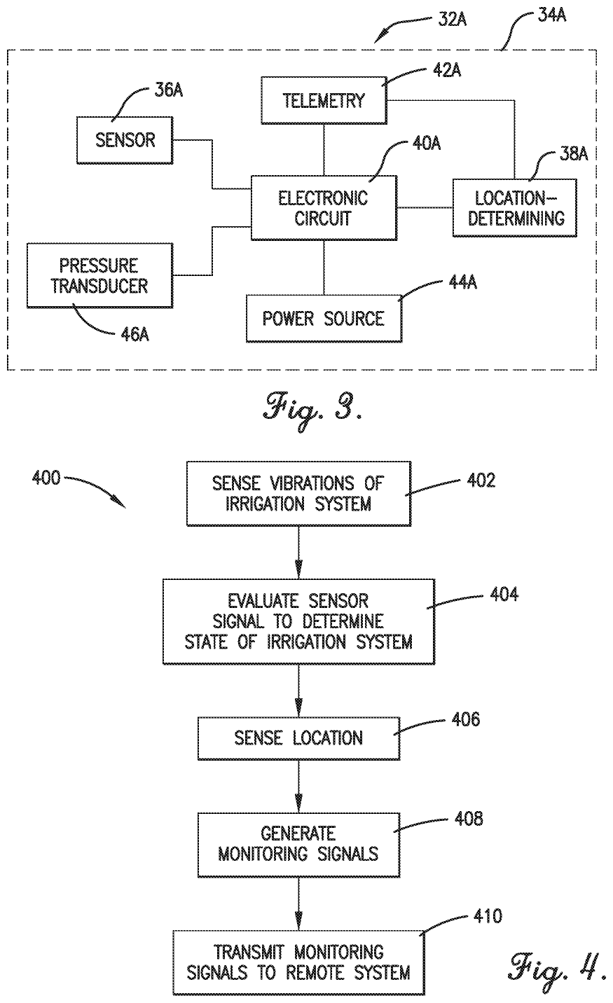

A monitoring terminal 32A constructed in accordance with another embodiment of the invention is illustrated in FIG. 3. As with monitoring terminal 32 of FIG. 2, the monitoring terminal 32A includes a housing 34A; a sensor 36A; a location-determining component 38A; an electronic circuit 40A; a telemetry unit 42A; and a power source 44A. All of these components are essentially identical to the same-named components of the monitoring terminal 32 shown in FIG. 2 and will therefore not be described in detail again. In addition, the monitoring terminal 32A includes a pressure transducer 46A that may be coupled with a fluid port of the irrigation system to directly sense water pressures in a fluid-carrying conduit of the irrigation system. Thus, in this embodiment, the pressure transducer 46A senses and provides water pressure data to the electronic circuit 40A to detect when water is being discharged from the irrigation system. Instead of a pressure transducer, this embodiment or other embodiments of the mounting terminal may include a fluid flow meter, a level switch, or other fluid-sensing component.

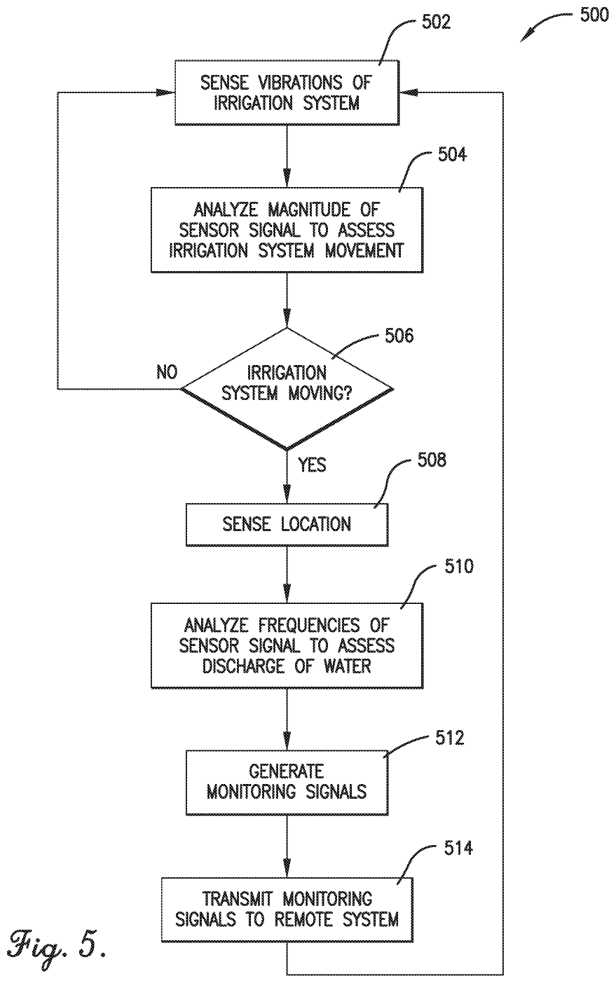

Operation of the above-described monitoring terminals 32 and 32A will now be described with reference to FIGS. 4 and 5. The flow chart of FIG. 4 shows the functionality and operation of an exemplary method 400 of the present technology. Some of the blocks of the flow chart may represent a step in the method 400 and/or a module section or portion of code of computer programs that operate the electronic circuit 40 or 40A. In some alternative implementations, the functions noted in the various blocks may occur out of the order depicted in FIG. 4. For example, two blocks shown in succession in FIG. 4 may in fact be executed substantially concurrently, or the block may sometimes be executed in the reverse order depending upon the functionality involved.

The method 400 begins in step 402 where one of the sensors 36,36A senses vibrations of the irrigation system 10 and generates corresponding sensor signals and sends them to the corresponding electronic circuit 40,40A.

In step 404, one of the electronic circuits 40,40A evaluates the sensor signals to determine an operating state of the irrigation system 10. The operating states that are detected may relate to movement of the irrigation system and/or water discharge from the irrigation system. Specific operating states may include, for example: a) the irrigation system is not moving and not discharging water, b) the irrigation system is not moving but discharging water, c) the irrigation system is moving and discharging water, or d) the irrigation system is moving but not discharging water.

In one embodiment, the electronic circuit 40,40A evaluates both the magnitude and frequency spectrum of the sensor signals to determine the operating states of the irrigation system. The electronic circuit 40,40A analyzes the magnitude of the sensor signals to determine if the irrigation system is stationary or moving. If the irrigation system is moving, the electronic circuit analyzes frequencies of the sensor signals to determine whether the irrigation system is discharging water. More specific detection schemes are described below in connection with FIG. 5.

In step 406, the electronic circuit 40,40A may receive position or orientation information from the location-determining component 38,38A or a similar device. This step, and all other steps of the method, may be performed in a different order. For example, the position of the irrigation system may be determined before, during, or after steps 402 or 404.

In step 408, the electronic circuit 40,40A generates monitoring signals that represent the operating state of the irrigation system. For example, a first monitoring signal may indicate the irrigation system is moving and discharging water, and a second monitoring signal may indicate a current position of the irrigation system.

In step 410, the telemetry system 42,42A transmits the monitoring signals and/or related data to an irrigation monitoring system located remotely from the irrigation system. Such data may be used to remotely monitor the operation of the irrigation system and/or to make changes in an irrigation schedule.

The flow chart of FIG. 5 shows the functionality and operation of another exemplary method 500 of the present technology. Some of the blocks of the flow chart may represent a step in the method 500 and/or a module section or portion of code of computer programs that operate one of the electronic circuits 40,40A. In some alternative implementations, the functions noted in the various blocks may occur out of the order depicted in FIG. 5. For example, two blocks shown in succession in FIG. 5 may in fact be executed substantially concurrently, or the block may sometimes be executed in the reverse order depending upon the functionality involved.

The method 500 begins in step 502 where one of the sensors 36,36A senses vibrations of the irrigation system and generates corresponding sensor signals and sends them to the corresponding electronic circuit 40,40A.

In steps 504 and 506, the electronic circuit 40,40A evaluates the sensor signals to determine if the irrigation system 10 is stationary or moving. In one embodiment, the electronic circuit 40,40A compares the magnitude of the sensor signals to a pre-selected threshold magnitude level. A sensed magnitude that is greater than the threshold level indicates irrigation system movement, and a sensed magnitude that is less than the threshold level indicates irrigation system is not moving. This step is performed to distinguish between low amplitude vibrations caused by wind, nearby machinery, etc. and higher amplitude vibrations that indicate irrigation system movement. The value of the threshold magnitude level may vary depending on the size and type of irrigation system as well as the method of mounting the monitoring terminal, but will typically be between 0.005 g and 0.5 g.

If the electronic circuit 40,40A determines the irrigation system 10 is not moving in step 506, the method returns to step 502 to continue sensing vibrations of the irrigation system.

But if the electronic circuit 40,40A determines the irrigation system 10 is moving in step 506, the method continues to step 508 where the electronic circuit 40,40A sends a “wake-up” signal to the location-determining component 38,38A so that the location-determining component begins to receive and process satellite signals. The electronic circuit waits to wake-up the location determining component until irrigation system movement is sensed because GPS receivers use relatively high amounts of power to scan for and analyze satellite signals. By waiting to power up the location determining component until movement is sensed, battery charge is preserved.

Before, during, or after step 508, the electronic circuit 40,40A also analyzes frequencies of the sensor signals to determine whether the irrigation system is discharging water as depicted in step 510. In one embodiment, the electronic circuit segregates the sensor signals into low frequency and high frequency components, divides the energy of the low frequency components by the energy of the high frequency components, and then compares the result to a threshold value to determine if the irrigation system is discharging water. If the result is greater than the threshold value, then the irrigation system is believed to be discharging water, and if the result is less than the threshold value, the irrigation system is not discharging water. Applicant has discovered these steps accurately detect water flow because the weight of water in the irrigation system when discharging water dampens the high frequency vibrations generated by the irrigation system's motors. In one embodiment, the electronic circuit uses a frequency of 100 Hz when segregating the sensor signals into low frequency and high frequency components, but any segregation frequency between 25 Hz and 250 Hz works reasonably well.

The electronic circuit 40,40A may also detect patterns in the vibration signals to determine operating states. For example, if the vibrations have a repeating duty cycle, this indicates movement because the irrigation system motors may be turned on and off to maintain alignment, thus causing vibrations that increase and decrease repeatedly.

In step 512, the electronic circuit 40,40A generates monitoring signals that represent the operating state of the irrigation system 10. For example, a first monitoring signal may indicate the irrigation system is moving and discharging water, and a second monitoring signal may indicate a current position of the irrigation system. In step 514, the telemetry system 42,42A transmits the monitoring signals to the remote irrigation monitoring system for monitoring and analysis.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. For example, the principles of the present invention are not limited to the illustrated center pivot irrigation systems but may be implemented in any type of irrigation system including linear move irrigation systems.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Some of the functions described herein may be implemented with one or more computer programs executed by one of the electronic circuits 40,40A. Each computer program comprises an ordered listing of executable instructions for implementing logical functions and can be embodied in any computer-readable medium for use by or in connection with an instruction execution system, apparatus, or device that can fetch the instructions and execute the instructions. In the context of this application, a “computer-readable medium” can be any means that can contain, store, communicate, propagate or transport the program for use by or in connection with the instruction execution system, apparatus, or device including, but not limited to, the memory of the electronic circuits 40,40A. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), an optical fiber, and a portable compact disk read-only memory (CDROM).

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, processing elements such as the electronic circuits 40,40A may be implemented as special purpose computers or as general purpose computers. For example, the electronic circuits may comprise dedicated circuitry or logic that is permanently configured, such as an application-specific integrated circuit (ASIC), or indefinitely configured, such as an FPGA, to perform certain operations. The electronic circuits may also comprise programmable logic or circuitry (e.g., as encompassed within a general-purpose processor or other programmable processor) that is temporarily configured by software to perform certain operations. It will be appreciated that the decision to implement the electronic circuits as special purpose, in dedicated and permanently configured circuitry, or as general purpose (e.g., configured by software) may be driven by cost and time considerations.

Accordingly, the terms “electronic circuits,” “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the electronic circuits are temporarily configured (e.g., programmed), each of the processing elements need not be configured or instantiated at any one instance in time. For example, where the electronic circuits comprise a general-purpose processor configured using software, the general-purpose processor may be configured as respective different processing elements at different times. Software may accordingly configure the electronic circuits to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of the methods 400,500 may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Having thus described the preferred embodiment of the invention, what is claimed as new and desired to be protected by Letters Patent includes the following:

1. A monitoring terminal for monitoring operation of a moveable irrigation system, the monitoring terminal comprising:
a housing that may be attached to a component of the irrigation system;
a sensor mounted in the housing that senses vibrations of the irrigation system and generates a corresponding sensor signal;
an electronic circuit mounted in the housing and electrically coupled with the sensor, the electronic circuit operable to—
evaluate attributes of the sensor signal to determine operating states of the irrigation system, the operating states comprising: a) the irrigation system is not moving and not discharging water, b) the irrigation system is not moving but discharging water, c) the irrigation system is moving and discharging water, and d) the irrigation system is moving but not discharging water,
generate a monitoring signal that represents at least one of the operating states of the irrigation system; and
a telemetry unit for transmitting the monitoring signal to an irrigation monitoring system located remotely from the irrigation system.

2. The monitoring terminal of claim 1, further comprising a power source mounted in or on the housing for powering the sensor, the electronic circuit, and the telemetry unit without any electrical connections to an electrical system of the irrigation system.

3. The monitoring terminal of claim 2, wherein the power source is a solar panel and a battery coupled with the solar panel.

4. The monitoring terminal of claim 2, further comprising a GPS receiver positioned in the housing and powered by the power source for receiving GPS satellite signals, determining positions of the irrigation system from the GPS satellite signals, and generating corresponding position signals, the telemetry unit further operable to transmit the position signals to the irrigation monitoring system.

5. The monitoring terminal of claim 1, wherein the sensor is an accelerometer.

6. The monitoring terminal of claim 1, wherein the electronic circuit includes a processor.

7. The monitoring terminal of claim 1, wherein the electronic circuit analyzes the magnitude of the sensor signal to determine if the irrigation system is stationary or moving, and only if the irrigation system is moving, analyzes frequencies of the sensor signal to determine whether the irrigation system is discharging water.

8. A monitoring terminal for monitoring operation of a moveable irrigation system, the monitoring terminal comprising:
a housing that may be attached to a component of the irrigation system;
a sensor mounted in the housing that senses vibrations of the irrigation system and generates a corresponding sensor signal;
an electronic circuit mounted in the housing and electrically coupled with the sensor, the electronic circuit operable to—
analyze a magnitude of the sensor signal to detect a repeating duty cycle to determine if the irrigation system is stationary or moving,
if the irrigation system is moving, analyze frequencies of the sensor signal to determine if the irrigation system is discharging water, wherein the electronic circuit segregates the sensor signal into low frequency and high frequency components, divides an energy of the low frequency components by an energy of the high frequency components, and then compares a result of the divides step to a threshold value to determine if the irrigation system is discharging water, and
generate monitoring signals that represent whether the irrigation system is moving and whether the irrigation system is discharging water; and
a telemetry unit for transmitting the monitoring signals to an irrigation monitoring system located remotely from the irrigation system.

9. The monitoring terminal of claim 8, further comprising a power source mounted in or on the housing for powering the sensor, the electronic circuit, and the telemetry unit without any electrical connections to an electrical system of the irrigation system.

10. The monitoring terminal of claim 9, wherein the power source is a solar panel and a battery coupled with the solar panel.

11. The monitoring terminal of claim 9, further comprising a GPS receiver positioned in the housing and powered by the power source for receiving GPS satellite signals, determining positions of the irrigation system from the GPS satellite signals, and generating corresponding position signals, the telemetry unit further operable to transmit the position signals to the irrigation monitoring system.

12. The monitoring terminal of claim 8, wherein the sensor is an accelerometer.

13. The monitoring terminal of claim 8, wherein the electronic circuit includes a processor.

14. A monitoring terminal for monitoring operation of a moveable irrigation system without electrically connecting to an electrical system of the irrigation system and without fluidly connecting to a water conduit of the irrigation system, the monitoring terminal comprising:
a housing that may be attached to a component of the irrigation system;
an accelerometer mounted in the housing that senses vibrations of the irrigation system and generates a corresponding sensor signal;
an electronic circuit mounted in the housing and electrically coupled with the accelerometer, the electronic circuit operable to—
compare a magnitude of the sensor signal to a threshold magnitude level to determine if the irrigation system is stationary or moving,
if the irrigation system is moving, compare low frequency portions of the sensor signal to high frequency portions of the sensor signal to determine if the irrigation system is discharging water, and
generate monitoring signals that represent whether the irrigation system is moving and whether the irrigation system is discharging water;
a GPS receiver positioned in the housing for receiving GPS satellite signals, determining positions of the irrigation system from the GPS satellite signals, and generating corresponding position signals, wherein the GPS receiver is normally in a sleep mode, and wherein the electronic circuit is further operable to send a wake-up signal to the GPS receiver if it determines the irrigation system is moving after analyzing the sensor signal;
a telemetry unit for transmitting the monitoring signals and the position signals to an irrigation monitoring system located remotely from the irrigation system; and
a power source mounted in or on the housing for powering the accelerometer, the electronic circuit, the GPS receiver and the telemetry unit without any electrical connections to the electrical system of the irrigation system.

15. The monitoring terminal of claim 14, wherein the electronic circuit includes a processor.
